(19) United States
(12) Patent Application Publication
(10) Pub. No.: US 2014/0289619 A1
(43) Pub. Date: Sep. 25, 2014

(54) INFORMATION DISPLAY DEVICE

(71) Applicant: KABUSHIKI KAISHA TOSHIBA, Tokyo (JP)

(72) Inventors: Yuto Yamaji, Kawasaki-shi (JP); Tsuyoshi Tasaki, Yokohama-shi (JP); Kaoru Suzuki, Yokohama-shi (JP); Kazunori Imoto, Kawasaki-shi (JP); Yasunobu Yamauchi, Yokohama-shi (JP)

(73) Assignee: KABUSHIKI KAISHA TOSHIBA, Tokyo (JP)

(21) Appl. No.: 14/178,629

(22) Filed: Feb. 12, 2014

(30) Foreign Application Priority Data
Mar. 25, 2013 (JP) 2013-063048

(51) Int. Cl. G06F 3/01; G06F 3/0484; G06K 9/00; G06F 3/0488

(52) U.S. Cl. CPC G06F 3/017; G06F 3/0488; G06F 3/04845; G06K 9/00335
USPC 715/272

(57) ABSTRACT

According to an embodiment, an information display device includes a receiving unit, a processor, a generating unit, an associating unit, and a controller. The receiving unit receives input of a stroke with respect to at least one of either a first document or a second document displayed on a display. The processor analyzes the stroke, at least whether the stroke is an area specifying stroke or whether the stroke is an association stroke. When the stroke is an area specifying stroke, the generating unit generates area information of the area. When the stroke is an association stroke, the associating unit associates the first document with the area information. Based on an operation, the controller displays, on the display, a list of one or more pieces of the area information that are associated to the first document.

### CROSS-REFERENCE TO RELATED APPLICATIONS

This application is based upon and claims the benefit of priority from Japanese Patent Application No. 2013-063048, filed on Mar. 25, 2013; the entire contents of which are incorporated herein by reference.

### FIELD

Embodiments described herein relate generally to an information display device.

### BACKGROUND

A technology is known in which a plurality of pieces of window information is associated; and, when one piece of window information is closed, an icon of the one piece of window information is displayed in an associated manner to the other pieces of window information.

In such a conventional technology, since the associated information is displayed in the form of an icon, there occurs a decline in the perspicuity of the contents of the associated information.

### BRIEF DESCRIPTION OF THE DRAWINGS

FIG. 1 is a configuration diagram illustrating an example of an information display device according to a first embodiment;

FIG. 2 is a diagram for explaining an area specification stroke according to the first embodiment;

FIG. 3 is a diagram for explaining inclusion of an area specification stroke according to the first embodiment;

FIG. 4 is a diagram illustrating an example of an area specification stroke and an attachment stroke according to the first embodiment;

FIG. 5 is a diagram illustrating an example of an association stroke according to the first embodiment;

FIG. 6 is a diagram illustrating an example of the result of association according to the first embodiment;

FIG. 7 is a diagram illustrating a display example of the list display according to the first embodiment;

FIG. 8 is a flowchart for explaining an exemplary sequence of operations performed according to the first embodiment;

FIG. 9 is a flowchart for explaining an exemplary sequence of operations during an association operation performed according to the first embodiment;

FIG. 10 is a flowchart for explaining a sequence of operations during a list displaying operation performed according to the first embodiment;

FIG. 11 is a configuration diagram illustrating an example of an information display device according to a second embodiment;

FIG. 12 is a diagram illustrating a display example of the normal list display according to the second embodiment;

FIG. 13 is a diagram illustrating a display example of the list display of groupings according to the second embodiment;

FIG. 14 is a configuration diagram illustrating an example of an information display device according to a third embodiment;

FIG. 15 is a diagram illustrating exemplary association strokes according to the third embodiment;

FIG. 16 is a diagram illustrating a display example of the list display performed based on degrees of importance according to the third embodiment;

FIG. 17 is a configuration diagram illustrating an example of an information display device according to a fourth embodiment;

FIG. 18 is a diagram illustrating a display example of the normal list display according to the fourth embodiment;

FIG. 19 is a diagram illustrating an example of duplication performed according to the fourth embodiment; and

FIG. 20 is a diagram illustrating an exemplary hardware configuration of the information display device according to the embodiments.

### DETAILED DESCRIPTION

According to an embodiment, an information display device includes a receiving unit, a processor, a generating unit, an associating unit, and a controller. The receiving unit receives input of a stroke with respect to at least one of either a first document or a second document displayed on a display. The processor analyzes the stroke, at least whether the stroke is an area specifying stroke which specifies an area in the second document or whether the stroke is an association stroke which associates the first document with area in the second document. When the stroke is an area specifying stroke, the generating unit generates area information of the area. When the stroke is an association stroke, the associating unit associates the first document with the area information. Based on an operation, the controller displays, on the display, a list of one or more pieces of the area information that are associated to the first document.

Various embodiments will be described below in detail with reference to the accompanying drawings.

### First Embodiment

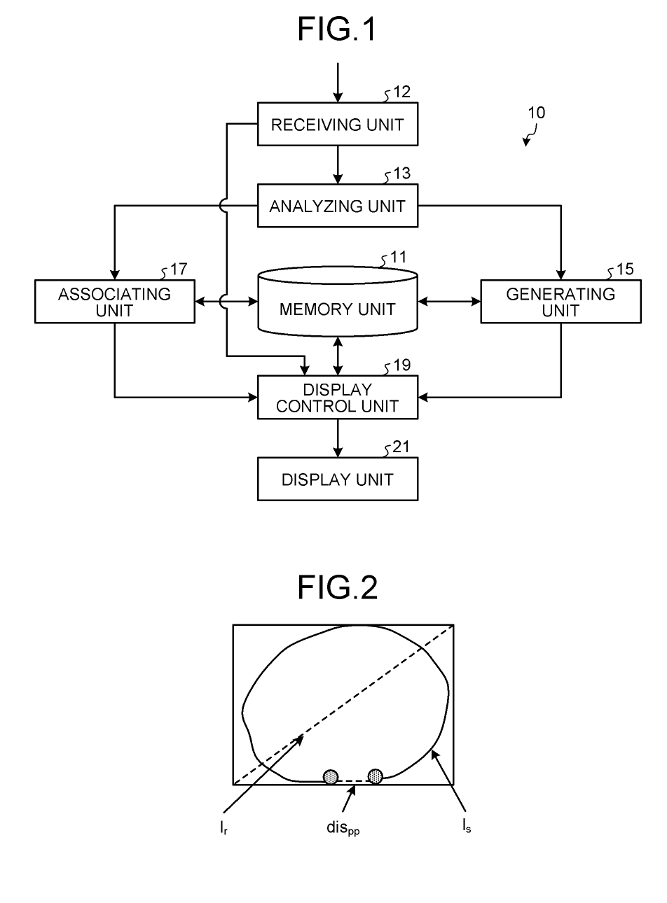

FIG. 1 is a configuration diagram illustrating an example of an information display device 10 according to a first embodiment. As illustrated in FIG. 1, the information display device 10 includes a memory unit 11, a receiving unit 12, an analyzing unit 13, a generating unit 15, an associating unit 17, a display control unit 19, and a display unit 21.

The memory unit 11 is used to store various computer programs executed in the information display device 10 and to store data that is used during various operations performed in the information display device 10. The memory unit 11 can be configured with a memory device capable of magnetically, optically, or electrically storing information. Examples of such a memory device include a hard disk drive (HDD), a solid state drive (SSD), a memory card, an optical disk, a read only memory (ROM), and a random access memory (ROM).

The receiving unit 12, the analyzing unit 13, the generating unit 15, the associating unit 17, and the display control unit 19 can be implemented by executing computer programs in a processor such as a central processing unit (CPU), that is, can be implemented using software; or can be implemented using hardware such as an integrated circuit (IC); or can be implemented using a combination of software and hardware.

The display unit 21 can be implemented using a display device such as a touch-sensitive display or a liquid crystal display.

The receiving unit 12 receives input of strokes with respect to at least either one of a first document and a second document that are being displayed on the display unit 21. More particularly, from an input unit (not illustrated), the receiving unit 12 receives input of strokes with respect to at least either one of the first document and the second document that are being displayed on the display unit 21.

Herein, the input unit can be implemented using an input device such as a touch-sensitive panel, a touch-pad, a mouse, or an electronic pen that enables handwritten input. In the first embodiment, it is assumed that the input unit is a touch-sensitive panel, and that a user inputs strokes by writing a character or a drawing on the touch-sensitive panel by hand using a stylus pen or a finger. However, that is not the only possible case. Alternatively, for example, the input unit can also be implemented using a touch-pad, a mouse, or an electronic pen.

Herein, “stroke” points to a stroke of a character or a drawing that is input in handwriting by the user, and represents data of the locus from the time when a stylus pen or a finger makes contact with the input screen of the touch-sensitive panel until it is lifted from the input screen (i.e., locus from a pen-down action to a pen-up action). A stroke is expressed as time-series coordinate values, such as {(x₁, y₁), (x₂, y₂), . . . , (xₙ, yₙ)}, of the contact points of the stylus pen or a finger with the input screen. However, the representational form of strokes is not limited to this example.

The receiving unit 12 also receives input of various operations.

The analyzing unit 13 analyzes the strokes received by the receiving unit 12. More particularly, the analyzing unit 13 analyzes whether a stroke received by the receiving unit 12 is an area specification stroke that specifies a particular area in the second document, or is an attachment stroke that attaches information to the particular area in the second document, or is an association stroke that associates the first document and area information.

For example, if the stroke received by the receiving unit 12 forms a closed loop in the second document and has a size equal to or greater than a certain size; then the analyzing unit 13 analyzes that the stroke is an area specification stroke. Moreover, for example, if the second document has a document structure, then the analyzing unit 13 determines whether or not the stroke received by the receiving unit 12 corresponds to an enclosing line or an underline with respect to some part of the document structure. If that stroke corresponds to an enclosing line or an underline with respect to some part of the document structure, then the analyzing unit 13 analyzes that the stroke is an area specification stroke.

The document structure is expressed using bounding rectangles indicating areas including characters, areas including lines, and areas including drawings; and using character codes indicating the meaning of the document structure. Whether the received stroke is an area specification stroke is determined by obtaining the overlapping on the x-axis and the y-axis between the bounding rectangles of the document structure and the bounding rectangle of the received stroke. If there is any overlapping area, then it is determined that the document structure is relevant to the received stroke.

The explanation regarding an area specification stroke is given below in concrete terms. For example, in the case of using an enclosing line or an underline as a stroke; firstly, circular shape determination is performed with the assumption that other strokes represent underlines.

The circular shape determination is performed in the following manner. As illustrated in FIG. 2, if the bounding rectangle of a received stroke has a diagonal length lᵣ, has a distance disₚₚ between the start point and the end point, and has a stroke length lₛ; then threshold values are set as given below and the received stroke is determined to be circular in shape.

disₚₚ<0.31, and lₛ+disₚₚ>1.51ᵣ and lₛ+disₚₚ<3.01,

Then, the stroke subjected to such area specification is identified in detail compared to the document structures. A detailed document structure points to the smallest unit such as a character or a drawing. For example, it is better if meaningful units are used in a document.

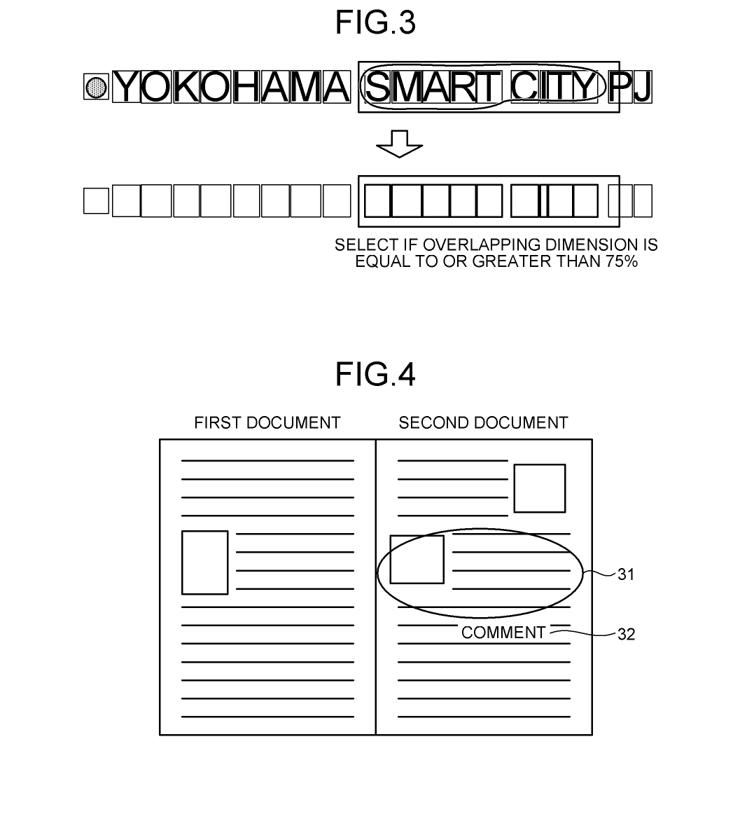

As a result of performing the circular shape determination, if a stroke is determined to be a circular stroke; then the sum of the dimensions of the bounding rectangles of the document structure is obtained. Moreover, the dimension of bounding rectangle of the stroke subjected to area specification is obtained. Then, a predetermined threshold value, such as 75% or more, of the ratio of the dimension (combined value) of the bounding rectangles of the document structure and the dimension of the stroke subjected to area specification is decided, and if the ratio is equal to or greater than the threshold value, a document structure is assumed to be included in the stroke subjected to the area specification. The document structure included in the stroke can be selected as annotation (see FIG. 3).

When an area specification stroke is determined to be an underline, it can be analyzed by obtaining the overlapping on the x-axis or the y-axis with the bounding rectangle of the received stroke. If the second document has a document structure, a rectangle that sufficiently overlaps the area of the document structure can be set.

Meanwhile, for example, if one of the ends of the stroke received by the receiving unit 12 specifies the first document and the other end specifies area information of the second document; then the analyzing unit 13 analyzes that the stroke is an association stroke.

Moreover, for example, if the stroke received by the receiving unit 12 is neither an area specification stroke nor an association stroke, then the analyzing unit 13 analyzes that the received stroke is an attachment stroke.

If the stroke received by the receiving unit 12 is an area specification stroke, then the generating unit 15 generates area information of the corresponding area and stores the area information in the memory unit 11. For example, the generating unit 15 generates, as the area information, an ID of the area in the second document which is specified by the area specification stroke, the start point, the width, the area specification stroke, and the like. Then, the generating unit 15 stores the area information in the memory unit 11 in a corresponding manner to page information of the second document.

If the stroke received by the receiving unit 12 is an attachment stroke, then the generating unit 15 generates additional information in a corresponding manner to the area information and stores the additional information in the memory unit 11. For example, the generating unit 15 generates, as the additional information, an attachment stroke, an ID of the attachment stroke, and an ID of area information corresponding to the additional information; and stores the additional information in the memory unit 11 in a corresponding manner to the page information of the second document.

FIG. 4 is a diagram illustrating an example of an area specification stroke and an attachment stroke according to the first embodiment. In the example illustrated in FIG. 4, a stroke 31 that forms a closed loop is an area specification stroke, while a stroke 32 that forms characters is an attachment stroke. The generating unit 15 generates area information of the area specified by the stroke 31, and stores the area information in the memory unit 11 in a corresponding manner to the page information of the second document. Moreover, the generating unit 15 generates additional information of the stroke 32 and stores the additional information in the memory unit 11 in a corresponding manner to the page information of the second document.

Meanwhile, when the stroke received by the receiving unit 12 is an association stroke, the associating unit 17 associates the first document and the area information. More particularly, if the stroke received by the receiving unit 12 is an association stroke, then the associating unit 17 generates association information that associates an area in the first document with the association information, and stores the association information in the memory unit 11.

For example, as the association information, the associating unit 17 generates information of the link source such as page information of the first document and an ID of the area in the first document, and generates information of the link destination such as page information of the second document and the position (start point) of the area information, and generates an association stroke. Then, the associating unit 17 stores the association information in the memory unit 11 in a corresponding manner to the area information.

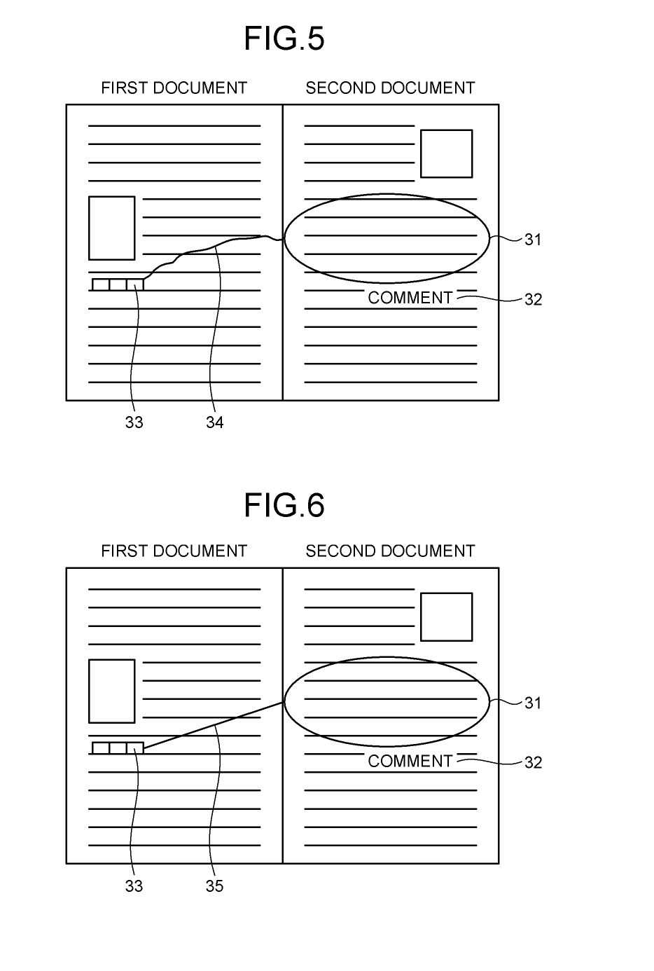

FIG. 5 is a diagram illustrating an example of the association stroke according to the first embodiment, and FIG. 6 is a diagram illustrating an example of the result of association according to the first embodiment. In the example illustrated in FIG. 5, a stroke 34 that joins an area 33 in the first document to the stroke 31 is an association stroke. The associating unit 17 generates association information of the stroke 34 and stores it in the memory unit 11 in a corresponding manner to the area information. Then, as illustrated in FIG. 6, the associating unit 17 converts the stroke 34 into a link 35 that joins the area 33 to the stroke 31. Herein, an icon indicating the number of links associated to the area 33 can also be displayed in the neighborhood of the area 33.

When the receiving unit 12 receives a predetermined operation, the display control unit 19 displays on the display unit 21 a list of one or more pieces of area information associated with the first document. More particularly, on the display unit 21, the display control unit 19 displays a list of one or more pieces of area information each of which has the corresponding additional information appended thereto.

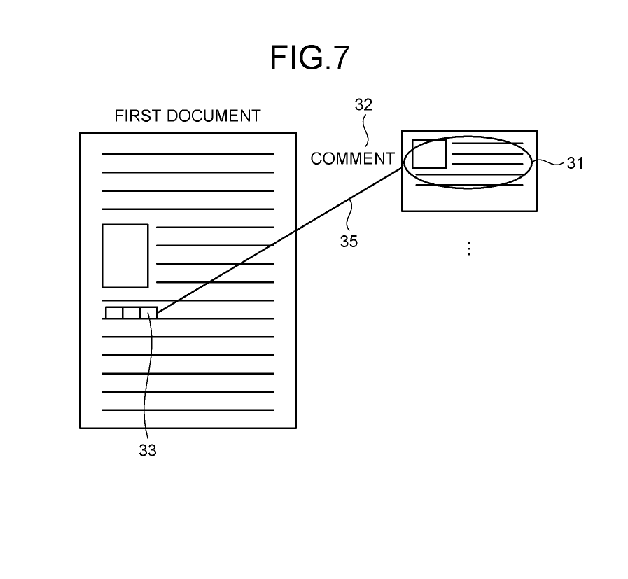

FIG. 7 is a diagram illustrating a display example of the list display according to the first embodiment. In the example illustrated in FIG. 7, when the receiving unit 12 receives a list display operation specifying the area 33; the display control unit 19 obtains, from the memory unit 11, the area information specified by the stroke 31 and the additional information of the stroke 32 associated to that area information, joins the area 33 to the obtained information using the link 35, and displays the obtained information as a list.

Examples of the display form of the area information include displaying the thumbnail of a clipping image of the area corresponding to the area information. Moreover, examples of the display form of the additional information include displaying the stroke corresponding to the additional information without modification, changing the position of the stroke corresponding to the additional information and displaying it in the neighborhood of the clipping image, or displaying the stroke corresponding to the additional information close to the link.

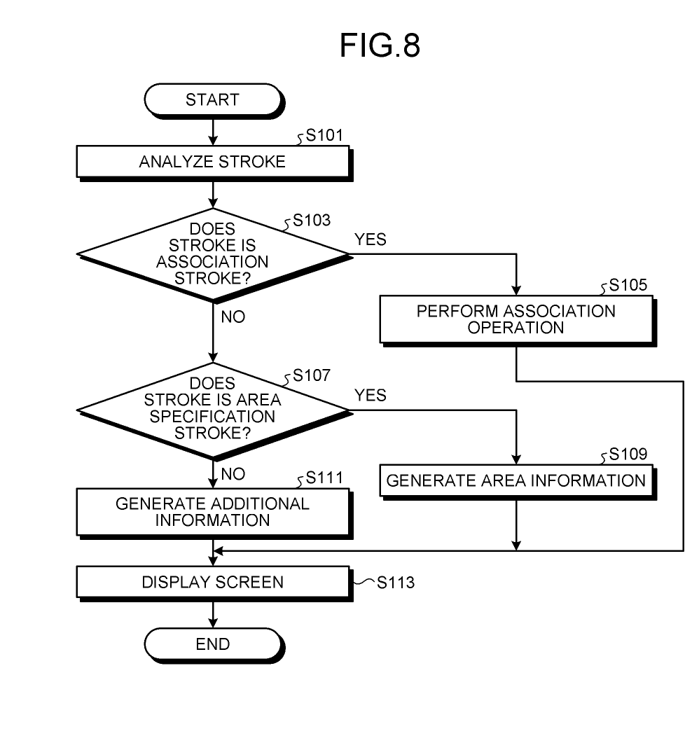

FIG. 8 is a flowchart for explaining an exemplary sequence of operations performed in the information display device 10 according to the first embodiment.

Firstly, when the receiving unit 12 receives a stroke, the analyzing unit 13 analyzes the received stroke (Step S101).

If the analysis result indicates that the received stroke is an association stroke (Yes at Step S103), then the associating unit 17 performs an association operation so as to associate the first document with the area information (Step S105). Then, the display control unit 19 displays a post-association-operation screen on the display unit 21 (Step S113).

If the analysis result indicates that the received stroke is an area specification stroke (No at Step S103, Yes at Step S107); then the generating unit 15 generates area information of the area specified in the area specification information (Step S109). Subsequently, the display control unit 19 displays a post-area-information-generation screen on the display unit 21 (Step S113).

In case the analysis result indicates that the received stroke is neither an association stroke nor an area specification stroke (No at Step S103, No at Step S107), then the received stroke happens to be an attachment stroke. Hence, the generating unit 15 generates additional information in a corresponding manner to the area information (Step S111). Then, the display control unit 19 displays a post-additional information-generation screen on the display unit 21 (Step S113).

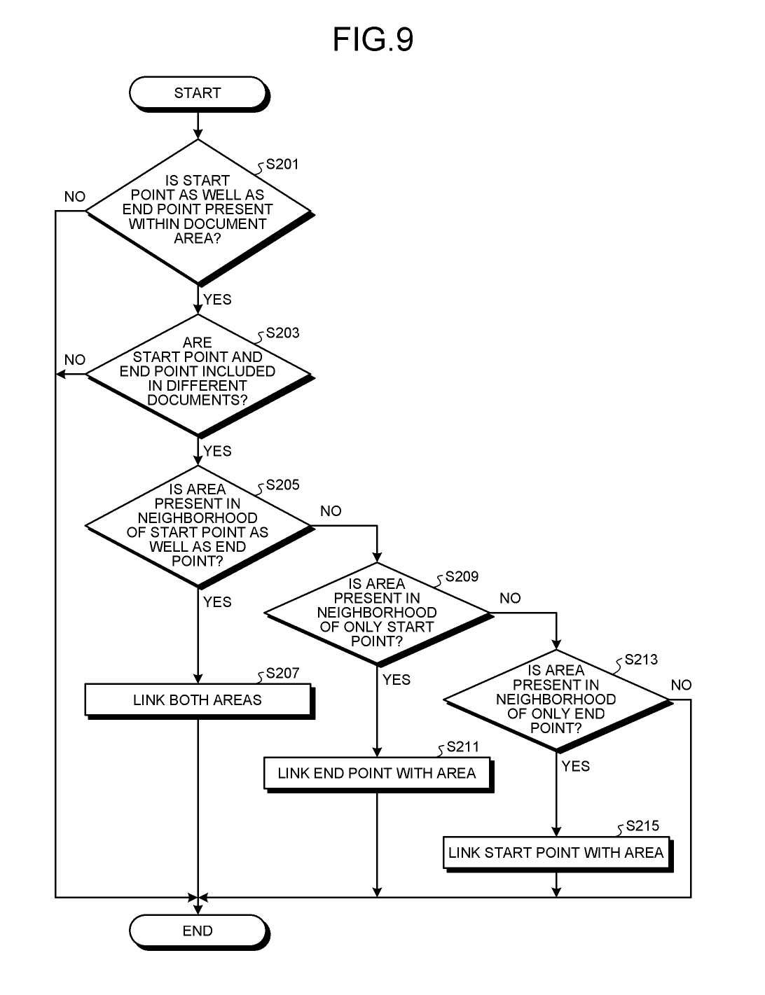

FIG. 9 is a flowchart for explaining an exemplary sequence of operations during the association operation performed in the information display device 10 according to the first embodiment.

Firstly, the analyzing unit 13 checks whether or not the start point and the end point of the stroke received by the receiving unit 12 are present within the document area (Step S201). If the start point and the end point of the received stroke are not present within the document area (No at Step S201), then the analyzing unit 13 analyzes that the received stroke is not an association stroke. That marks the end of the operations.

On the other hand, if the start point and the end point of the received stroke are present within the document area (Yes at Step S201), then it is checked whether or not the start point and the end point are included in different documents (Step S203). If the start point and the end point are included in the same document (No at Step S203), then the analyzing unit 13 analyzes that the received stroke is not an association stroke. That marks the end of the operations.

On the other hand, if the start point and the end point are not included in the same document (Yes at Step S203) and if an area is present in the neighborhood of the start point as well as in the neighborhood of the end point (Yes at Step S205), then the associating unit 17 links the two areas (Step S207).

In contrast, if an area is present in the neighborhood of only the start point (No at Step S205, Yes at Step S209), then the associating unit 17 links the end point to that area (Step S211).

If an area is present in the neighborhood of only the end point (No at Step S205, No at Step S209, Yes at Step S213), then the associating unit links the start point to that area (Step S215).

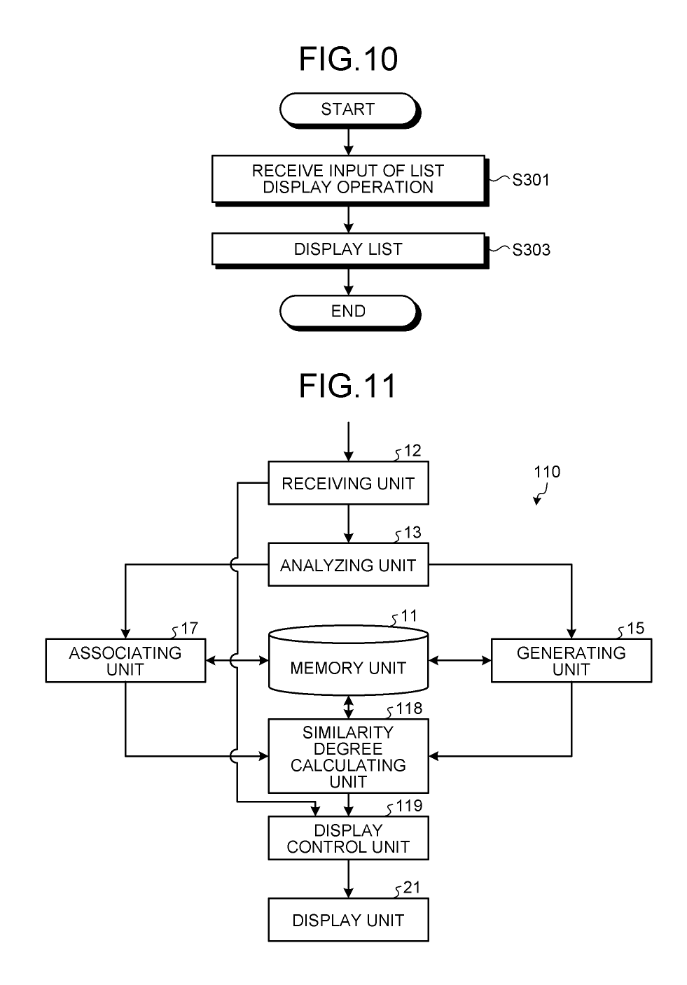

FIG. 10 is a flowchart for explaining a sequence of operations during a list displaying operation performed in the information display device 10 according to the first embodiment.

Firstly, the receiving unit 12 receives input of a list display operation (Step S301).

Once the receiving unit 12 receives a list display operation; the display control unit 19 displays, on the display unit 21, a list of one or more pieces of area information each of which is associated to the first document and has the corresponding additional information appended thereto (Step S303).

In this way, according to the first embodiment, the areas in the second document that are associated to the first document are displayed as a list. That enables achieving enhancement in the perspicuity of the contents of the associated information.

### Second Embodiment

In a second embodiment, the explanation is given about an example in which the area information is divided into groups and the groups are displayed. The following explanation is given with the focus on the differences with the first embodiment. Thus, the constituent elements having identical functions to the first embodiment are referred to by the same names/reference numerals, and the explanation thereof is not repeated.

FIG. 11 is a configuration diagram illustrating an example of an information display device 110 according to the second embodiment. As illustrated in FIG. 11, in the information display device 110 according to the second embodiment, a similarity degree calculating unit 118 and a display control unit 119 are different than the first embodiment.

The similarity degree calculating unit 118 calculates the degrees of similarity between one or more pieces of additional information. For example, the similarity degree calculating unit 118 performs character recognition with respect to the attachment stroke corresponding to each piece of additional information, and calculates the degrees of similarity between the character recognition results.

Moreover, for example, the similarity degree calculating unit 118 calculates the degrees of similarity between the attachment strokes. For example, from an attachment stroke, the similarity degree calculating unit 118 extracts the entire stroke line that is made of K number of strokes having continuous stroke numbers. If the stroke count of an attachment stroke is N and if K is equal to 3, then the similarity degree calculating unit 118 extracts (1, 2, 3), (2, 3, 4), . . . , (N−2, N−1, N) as the stroke line from that combination of N and K. In an identical manner, from a target attachment stroke for comparison too, the similarity degree calculating unit 118 calculates the entire stroke line that is made of K number of strokes having continuous stroke numbers. Then, the similarity degree calculating unit 118 normalizes the positions and the sizes of the stroke lines of both attachment strokes, and calculates the degree of similarity therebetween.

Based on the additional information corresponding to each of one or more pieces of area information, the display control unit 119 divides the one or more pieces of area information into groups (i.e., performs clustering) and displays a list of groups on the display unit 21. More particularly, the display control unit 119 groups such pieces of area information each of which corresponds to the additional information included in a combination having the degree of similarity equal to or greater than a threshold value; and displays a list of the groups on the display unit 21. Examples of the grouping form include a list structure or partial overlapping.

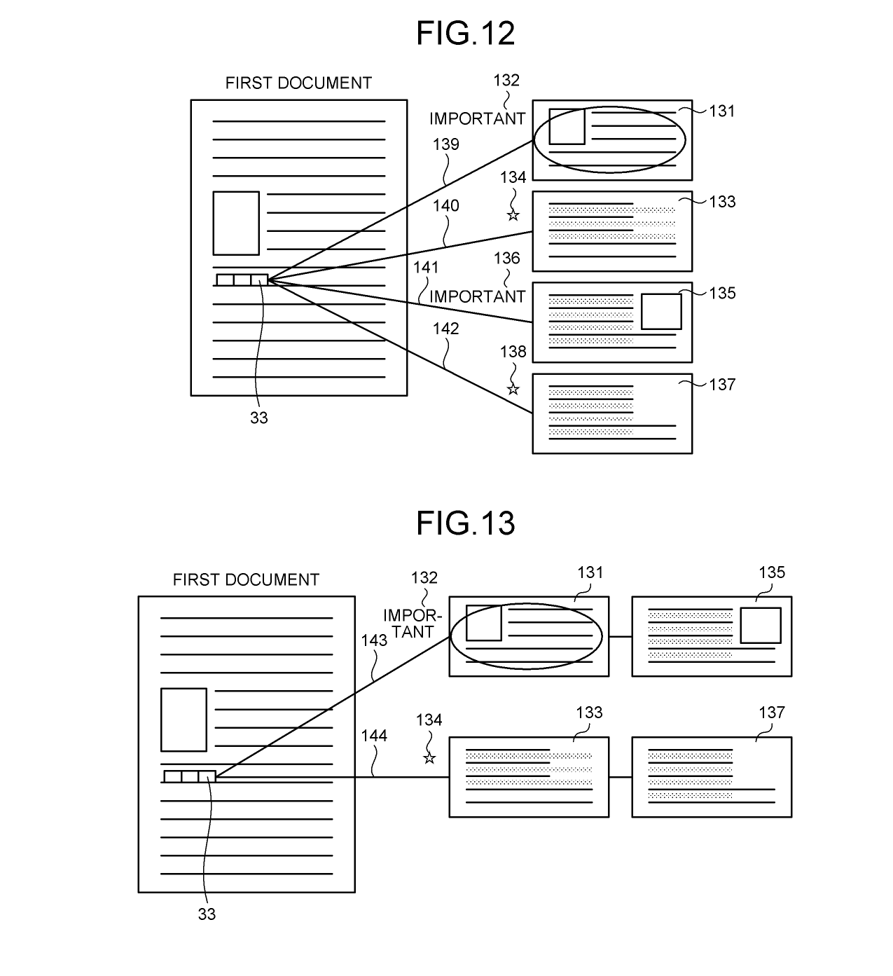

FIG. 12 is a diagram illustrating a display example of the normal list display according to the second embodiment. In the example illustrated in FIG. 12, when the receiving unit 12 receives a list display operation specifying the area 33, the display control unit 119 uses a link 139 to join the area 33 to the area information specified by a stroke 131 and the additional information of a stroke 132 associated to that area information, and performs display of the same; uses a link 140 to join the area 33 to the area information specified by a stroke 133 and the additional information of a stroke 134 associated to that area information, and performs display of the same; uses a link 141 to join the area 33 to the area information specified by a stroke 135 and the additional information of a stroke 136 associated to that area information, and performs display of the same; and uses a link 142 to join the area 33 to the area information specified by a stroke 137 and the additional information of a stroke 138 associated to that area information, and performs display of the same.

FIG. 13 is a diagram illustrating a display example of the list display of groupings according to the second embodiment. When the similarity degree calculating unit 118 calculates the degree of similarity between two combinations from among the stroke 132, the stroke 134, the stroke 136, and the stroke 138; since the stroke 132 and the stroke 136 are identical strokes and since the stroke 134 and the stroke 138 are identical strokes, the degree of similarity between the two combinations is equal to or greater than the threshold value.

For that reason, as illustrated in FIG. 13, the area information of the stroke 131 associated to the additional information of the stroke 132 and the area information of the stroke 135 associated to the additional information of the stroke 136 are grouped and joined by a link 143 and are displayed. Moreover, the area information of the stroke 133 associated to the additional information of the stroke 134 and the area information of the stroke 137 associated to the additional information of the stroke 138 are grouped and joined by a link 144 and are displayed on the display unit 21.

In the neighborhood of the group including the area information of the stroke 131 and the area information of the stroke 135, the display control unit 119 displays the additional information of the stroke 132 (or the stroke 136) that is used for the grouping purpose. Similarly, in the neighborhood of the group including the area information of the stroke 133 and the area information of the stroke 137, the display control unit 119 displays the additional information of the stroke 134 (or the stroke 138) that is used for the grouping purpose.

In the case when a plurality of pieces of additional information is present, then the pieces of additional information that are not used for the grouping purpose can be displayed in the respective pieces of area information as usual. Moreover, if any area information belongs to a plurality of groups, then that area information can either be displayed in all groups or be displayed in the group having the highest degree of similarity.

In this way, according to the second embodiment, the areas in the second document that are associated to the first document are grouped, and the groups are displayed in the form of a list. As a result, it becomes possible to further enhance the perspicuity of the contents of the associated information.

### Third Embodiment

In a third embodiment, the explanation is given about an example in which the area information having a high degree of importance is displayed on priority. The following explanation is given with the focus on the differences with the first embodiment. Thus, the constituent elements having identical functions to the first embodiment are referred to by the same names/reference numerals, and the explanation thereof is not repeated.

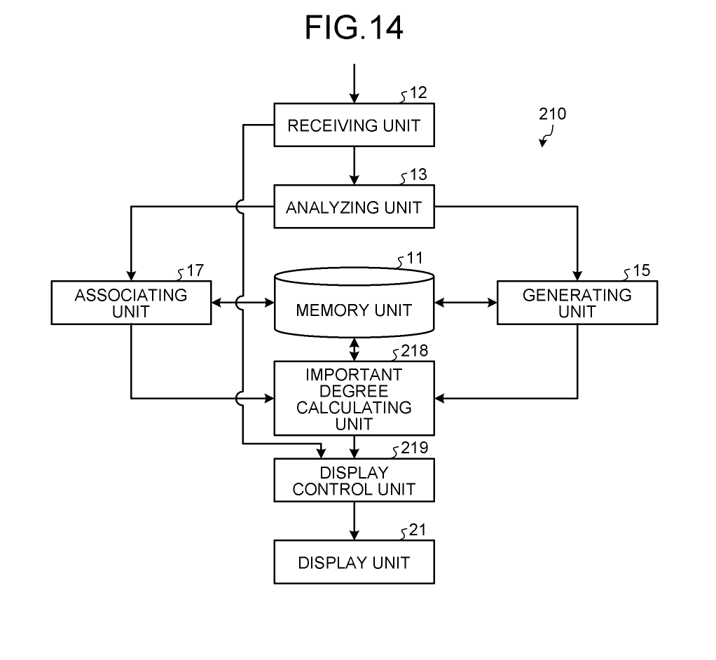

FIG. 14 is a configuration diagram illustrating an example of an information display device 210 according to the third embodiment. As illustrated in FIG. 14, in the information display device 210 according to the third embodiment, an important degree calculating unit 218 and a display control unit 219 are different than the first embodiment.

The important degree calculating unit 218 calculates, for each piece of area information, the degree of importance based on at least one of the association strokes, the area specification strokes, and the attachment strokes corresponding to that area information. In the case of calculating the degree of importance based on the association strokes; it is possible to make use of the number of association strokes (the association count), the thickness of the association strokes, the writing pressure of the association strokes, the shapes of the association strokes, and the timings of the association strokes. In the case of calculating the degree of importance based on the area specification strokes or based on the attachment strokes; it is possible to make use of the thickness, the writing pressure, the shape, and the additional information contents of the area specification strokes or the attachment strokes.

In the case of making use of the number of association strokes; greater the number, greater can be the degree of importance. In the case of making use of the thicknesses of the strokes; greater the thickness, greater can be the degree of importance. In the case of making use of the writing pressures of the strokes; greater the writing pressure, greater can be the degree of importance. In the case of making use of the colors of the strokes; the degree of importance can be greater for specific colors (such as red). In the case of making use of the shapes of the strokes, greater the complexity in the shape of a stroke, that is longer a stroke; greater can be the degree of importance. In the case of making use of the timings of the strokes; closer the timing to the current timing, greater can be the degree of importance. In the case of making use of the contents of the additional information; greater the frequency of occurrence of the contents, greater can be the degree of importance.

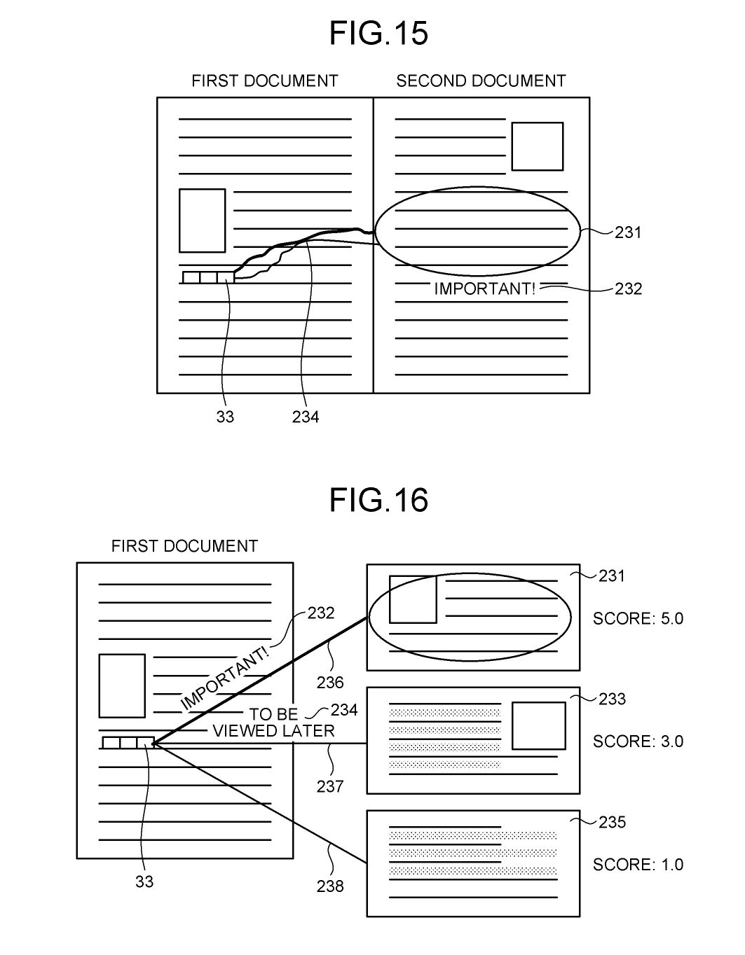

FIG. 15 is a diagram illustrating exemplary association strokes according to the third embodiment. In the example illustrated in FIG. 15, there are two association strokes that join the area 33 in the first document with a stroke 231; and the area information of the stroke 231 has a higher degree of importance than usual.

Based on the degrees of importance; the display control unit 219 displays, on the display unit 21, a list of one or more pieces of area information that are associated to the first document. More particularly, on the display unit 21, the display control unit 219 displays, in descending order of the degrees of importance, a list of one or more pieces of area information associated to the first document.

FIG. 16 is a diagram illustrating a display example of the list display performed based on the degrees of importance according to the third embodiment. In the example illustrated in FIG. 16, the area information of the stroke 231 has the highest degree of importance equal to a score of 5.0. Hence, that area information is displayed with the highest priority, and a link 236 is displayed in a highlighted manner.

In this way, according to the third embodiment, the areas in the second document that are associated to the first document are displayed in a list according to the degrees of importance. As a result, it becomes possible to further enhance the perspicuity of the contents of the associated information.

### Fourth Embodiment

In a fourth embodiment, the explanation is given about an example in which the area information and the additional information that are associated to each other are clipped out into another document. The following explanation is given with the focus on the differences with the first embodiment. Thus, the constituent elements having identical functions to the first embodiment are referred to by the same names/reference numerals, and the explanation thereof is not repeated.

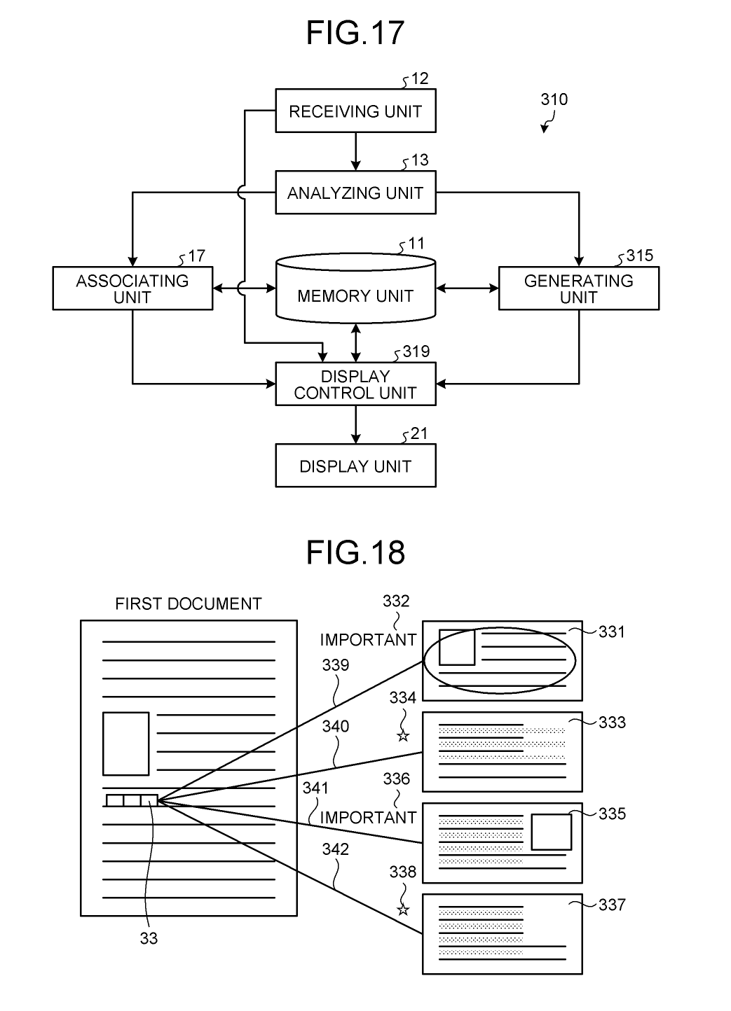

FIG. 17 is a configuration diagram illustrating an example of an information display device 310 according to the fourth embodiment. As illustrated in FIG. 17, in the information display device 310 according to the fourth embodiment, a generating unit 315 and a display control unit 319 are different than the first embodiment.

The generating unit 315 duplicates, in a third document, one or more pieces of area information and the additional information corresponding to each piece of area information.

FIG. 18 is a diagram illustrating a display example of the normal list display according to the fourth embodiment. In the example illustrated in FIG. 18, when the receiving unit 12 receives a list display operation specifying the area 33, the display control unit 319 uses a link 339 to join the area 33 to the area information specified by a stroke 331 and the additional information of a stroke 332 associated to that area information, and performs display of the same; uses a link 340 to join the area 33 to the area information specified by a stroke 333 and the additional information of a stroke 334 associated to that area information, and performs display of the same; uses a link 341 to join the area 33 to the area information specified by a stroke 335 and the additional information of a stroke 336 associated to that area information, and performs display of the same; and uses a link 342 to join the area 33 to the area information specified by a stroke 337 and the additional information of a stroke 338 associated to that area information, and performs display of the same.

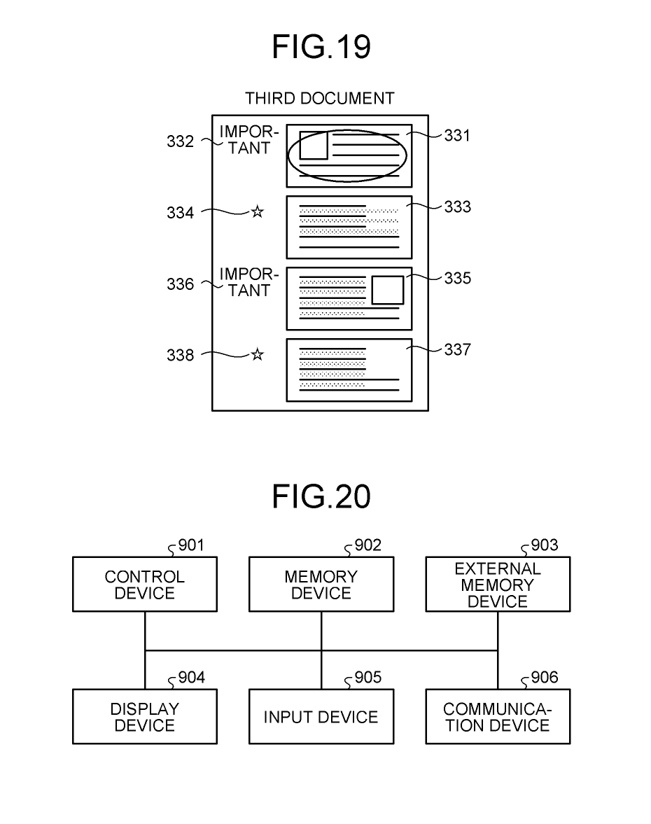

FIG. 19 is a diagram illustrating an example of the duplication performed according to the fourth embodiment. In the example illustrated in FIG. 19, the following information is duplicated in the third document: the area information specified by the stroke 331 and the additional information of the stroke 332 associated to that area information; the area information specified by the stroke 333 and the additional information of the stroke 334 associated to that area information; the area information specified by the stroke 335 and the additional information of the stroke 336 associated to that area information; and the area information specified by the stroke 337 and the additional information of the stroke 338 associated to that area information.

Meanwhile, in the third document, it is also possible to duplicate the thumbnail of the first document or to perform grouping as described in the second embodiment.

Hardware Configuration

FIG. 20 is a diagram illustrating an exemplary hardware configuration of the information display device according to the embodiments described above. Herein, the information display device according to the embodiments described above has the hardware configuration of a commonly-used computer that includes a control device 901 such as a central processing unit (CPU); a memory device 902 such as a read only memory (ROM) or a random access memory (RAM); an external memory device 903 such as a hard disk drive (HDD); a display device 904 such as a touch-sensitive panel; an input device 905 such as a touch-sensitive panel; and a communication device 906 such as a communication interface.

Meanwhile, the computer programs that are executed in the information display device according to the embodiments described above are recorded in the form of installable or executable files in a computer-readable recording medium such as a compact disk read only memory (CD-ROM), a compact disk readable (CD-R), a memory card, a digital versatile disk (DVD), or a flexible disk (FD).

Alternatively, the computer programs that are executed in the information display device according to the embodiments described above can be saved as downloadable files on a computer connected to the Internet or can be made available for distribution through a network such as the Internet. Still alternatively, the computer programs that are executed in the information display device according to the embodiments described above can be stored in advance in a ROM.

Meanwhile, the computer programs that are executed in the information display device according to the embodiments described above contain a module for each of the abovementioned constituent elements to be implemented in a computer. As the actual hardware, for example, a CPU reads the computer programs from an HDD and runs them such that the computer programs are loaded in a RAM. As a result, the module for each of the abovementioned constituent elements is implemented in the computer.

For example, unless contrary to the nature thereof, the steps of the flowcharts according to the embodiments described above can have a different execution sequence, can be executed in plurality at the same time, or can be executed in a different sequence every time.

As described above, according to the embodiments described above, it is possible to enhance the perspicuity of the contents of the associated information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information display device comprising:
a receiving unit configured to receive input of a stroke with respect to at least one of either a first document or a second document displayed on a display;
a processor configured to analyze the stroke, at least whether the stroke is an area specifying stroke which specifies an area in the second document or whether the stroke is an association stroke which associates the first document with area in the second document;
a generating unit configured to, when the stroke is an area specifying stroke, generate area information of the area;
an associating unit configured to, when the stroke is an association stroke, associate the first document with the area information; and
a controller configured to, based on an operation, display, on the display, a list of one or more pieces of the area information that are associated to the first document.

2. The device according to claim 1, wherein
when the stroke is an attachment stroke that attaches information to the area, the generating unit is configured to generate additional information in a corresponding manner to the area information, and
the controller is configured to append, to each of the one or more pieces of area information, additional information corresponding to the area information and then display a list of the one or more pieces of area information and their corresponding pieces of additional information on the display.

3. The device according to claim 2, wherein, based on the additional information corresponding to the one or more pieces of area information, the controller is configured to divide the one or more pieces of area information into groups and display a list of the groups on the display.

4. The device according to claim 3, further comprising a similarity degree calculator configured to calculate degrees of similarity between the one or more pieces of additional information, wherein
the controller is configured to group pieces of area information, each of which corresponds to additional information included in a combination having the degree of similarity equal to or greater than a threshold value, and displays a list of groups on the display.

5. The device according to claim 2, further comprising an important degree calculator configured to, for each piece of area information, calculate a degree of importance based on at least one of association strokes corresponding to the piece of area information, area specification strokes corresponding to the piece of area information, and attachment strokes corresponding to the piece of area information, wherein
based on the degree of importance, the controllers configured to display, on the display, a list of the one or more pieces of area information associated to the first document.

6. The device according to claim 5, wherein the controller is configured to display, on the display, a list of the one or more pieces of area information associated to the first document in descending order of the degree of importance.

7. The device according to claim 2, wherein the generating unit is configured to duplicate, in a third document, the one or more pieces of area information and the additional information corresponding to each of the one or more pieces of area information.

8. An information display device comprising:
a receiving unit configured to receive input of an operation; and
a controller configured to, when input of the operation is received, display, on a display, a list of one or more pieces of area information together with a first document, the one or more pieces of area information related to areas in a second document and associated with the first document.
